(19) United States
(12) Patent Application Publication
(10) Pub. No.: US 2015/0108940 A1
(43) Pub. Date: Apr. 23, 2015

(54) ELECTRICAL ENERGY STORE DEVICE

(71) Applicant: Philipp ZIPF, Stuttgart-Zuffenhausen (DE)

(72) Inventor: Philipp ZIPF, Stuttgart-Zuffenhausen (DE)

(73) Assignee: Robert Bosch GmbH, Stuttgart (DE)

(21) Appl. No.: 14/516,852

(22) Filed: Oct. 17, 2014

(30) Foreign Application Priority Data
Oct. 17, 2013 (DE) 10 2013 221 113.9

(51) Int. Cl. H01M 10/42; H01M 2/34; H02J 7/00

(52) U.S. Cl. CPC H01M 10/425; H02J 7/0014; H01M 2/34; H01M 2200/00; H01M 2220/30; H01M 2010/4271
USPC 320/103; 429/160; 429/61

(57) ABSTRACT

An electrical energy store device includes at least two energy storage cells, which are interconnected in series in each case with at least one diode to form a neutral point, the charge states of the energy storage cells being balanceable with the aid of leakage currents of the diodes if dissimilar charge states of the energy storage cells are present.

### RELATED APPLICATION INFORMATION

The present application claims priority to and the benefit of German patent application no. 10 2013 221 113.9, which was filed in Germany on Oct. 17, 2013, the disclosure of which is incorporated herein by reference.

### FIELD OF THE INVENTION

The present invention relates to an electrical energy store device. The present invention further relates to a method for operating an electrical energy store device.

### BACKGROUND INFORMATION

It is believed to be understood to supply power tools with electrical energy from more than one battery. There will be great demand for such concepts from the market in the future, multiple known technologies being in existence which provide multiple voltage or power supply options.

For example, a switch is used to switch between different electrical energy store systems, the switch being configured to be electrical or mechanical.

So-called power OR-ing is also believed to be understood, in which electric charge balancing between involved electrical energy storage cells is carried out with the aid of diodes, for example.

It is further believed to be understood to design an ideal diode with the aid of a control circuit, the diode having an operating behavior of a diode, but lower power loss than a diode. Such diodes are already in use in power OR-ing systems for lawnmowers, in which multiple electrical power supply systems connected in parallel are present, the system having the highest voltage in each case taking over the power supply.

Patent document WO 2007/085105 A1 discusses a device for balancing at least two batteries or cells of a multicell battery, a battery management system and a balancing circuit being provided. The device provides for all battery cells to be interconnected to a battery monitoring system, the monitoring system measuring every single cell voltage, the battery temperature and the current. The described monitoring system is thus able to recognize a charge imbalance between the battery cells and a number of cells having an electric voltage which is higher than an allowed maximal voltage. These cells are balanced until the charge imbalance has been reduced to an acceptable level.

Patent document DE 10 2011 017 599 A1 discusses a storage device for storing electrical energy including at least two storage cells, the storage cells being charged with the aid of a physical charge variable which is provided by an electric charger, and a physical variable being monitored in each of the storage cells. The method provides for a control signal for controlling the charger to be transmitted to the charger as a function of the monitored variables, the charge variable being successively reduced as a function of the control signal.

### SUMMARY OF THE INVENTION

It is an object of the present invention to provide an improved electrical energy store system including at least two energy storage cells.

The object is achieved by an electrical energy store device including at least two energy storage cells, which are interconnected in series in each case with at least one diode to form a neutral point. The energy store device according to the present invention is characterized in that, if dissimilar charge states of the energy storage cells are present, the charge states of the energy storage cells may be balanced with the aid of leakage currents of the diodes. In this way, a purely passive charging process is provided for the particular energy storage cell to be charged, which takes place without any control unit whatsoever. During a subsequent normal operation of an electrical device supplied with electrical energy by the energy store device, balanced charge states advantageously cause the energy storage cells to heat up only slightly due to lower currents per branch. Advantageously, in this way a very cost-effective approach for balancing charge states of energy storage cells is provided.

The object is further achieved by a method for operating an electrical energy store device including at least two energy storage cells, which are interconnected in series in each case with at least one diode to form a neutral point, including the following steps:
operational non-use of the device; and
balancing charge states of the energy storage cells with the aid of leakage currents of the diodes.

Specific embodiments of the device according to the present invention and of the method according to the present invention are the subject matter of the further description herein.

One specific embodiment of the electrical energy store device is characterized in that a number n of energy storage cells are interconnected to form the neutral point. In this way, the concept according to the present invention is advantageously implementable or parameterizable with multiple energy storage cells. The charge to be balanced in each case flows into the energy storage cell having the lowest charge until the charges of all energy storage cells have been balanced.

A further specific embodiment of the energy store device according to the present invention is characterized in that in each case n diodes are connected in series to at least one energy storage cell. In this way, a safety aspect is implemented for the device, which takes into consideration that a second, redundant diode assumes the charge balancing function when a diode fails. In this way, the electrical energy storage cells are protected from excessive charging current in the event of a fault.

A further specific embodiment of the energy store device according to the present invention is characterized in that in each case at least one fuse element is connected in series to at least one electrical energy storage cell. In this way, a safety aspect is implemented, it being prevented that an electrical energy storage cell is charged with excessively high current in the event of a fault. In this way, a current limitation or an interruption of the charging process may be easily implemented.

A further specific embodiment of the energy store device according to the present invention is characterized in that the diodes are Schottky diodes. Schottky diodes are characterized, among other things, in that they have relatively high leakage currents in the reverse direction. This is used to charge the electrical energy storage cells whose charge is to be balanced with the aid of the leakage current of the Schottky diode. As a result, an electrical energy storage cell having a low charge is thus chargeable with an electrical energy storage cell having a higher charge via a leakage current of the Schottky diode. Due to the fact that the leakage current is low in relation to the maximally permissible charging current, advantageously no battery management whatsoever is required.

The present invention will be described in greater detail hereafter with further features and advantages based on several figures. All described or illustrated features, either alone or in any arbitrary combination, form the subject matter of the present invention, regardless of the summary thereof in the patent claims or their back reference, and regardless of the wording or representation thereof in the description or in the drawings. Already understood principles of power OR-ing are not addressed in greater detail.

### BRIEF DESCRIPTION OF THE DRAWINGS

FIG. 1 shows a schematic representation of a first specific embodiment of the device according to the present invention.

FIG. 2 shows a family of parameters of the leakage current plotted against the reverse voltages of the diodes.

FIG. 3 shows two time diagrams which explain the voltage-related convergence of the states of two energy storage cells in a schematic manner.

FIG. 4 shows a schematic flow of one specific embodiment of the method according to the present invention.

### DETAILED DESCRIPTION

De-balanced electrical storage cells within the sense of the present invention mean that the storage cells have dissimilar charge or voltage states. Such charge or voltage states may occur with a use of multiple storage cells in electrical devices when batteries having dissimilar charges are plugged into the device.

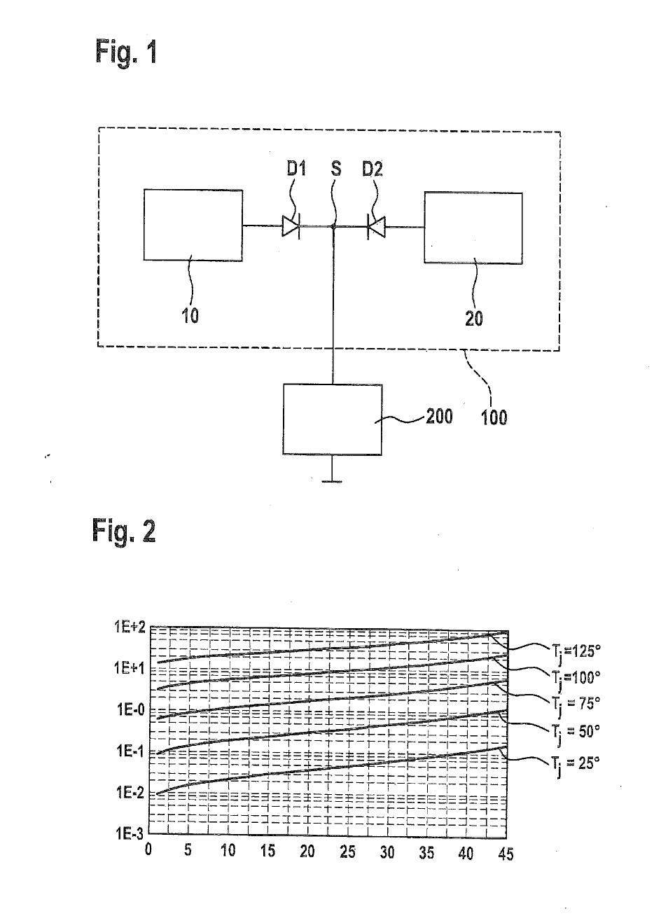

FIG. 1 shows a block diagram of a first specific embodiment of the electrical energy store device 100 according to the present invention. Device 100 is configured as a power OR-ing system including two branches and includes a first electrical energy storage cell 10 in a first branch and a second electrical energy storage cell 20 (e.g., lithium-ion cells) in a second branch. De-balanced energy storage cells 10, 20 are interconnected in each case with the aid of a forward biased diode D1, D2 to form a neutral point S. Diodes D1, D2 may be configured as Schottky diodes, which are characterized in that they have a relatively high leakage current (e.g., compared to silicon diodes) in the reverse direction, which may be as high as approximately 100 mA.

For the electric power supply of an electrical device 200, energy store device 100 is interconnected with electrical device 200. Electrical device 200 may be configured as a power tool, for example, such as an electric lawnmower, which has sufficient space for multiple energy storage cells 10, 20.

Due to the fact that the two diodes D1, D2 have high leakage currents in the reverse direction, one of the two diodes D1, D2 is forward biased and one of the two diodes D1, D2 is reverse biased in the case of de-balanced electrical energy storage cells 10, 20 having dissimilar voltages. With the aid of the leakage current, electrical energy storage cell 10, 20 having a lower charge is charged with the aid of electrical energy storage cell 10, 20 having a higher charge, whereby over time an equilibrium of the charge state of the two electrical energy storage cells 10, 20 takes effect.

It is assumed that electrical device 200 is not in normal operation, and the two electrical energy storage cells 10, 20 are plugged into their intended slots (not shown) within the electrical energy store device 100.

One alternative variant (not shown in the figures) of energy store device 100 according to the present invention provides for at least two diodes D1, D2 to be provided per branch of the power OR-ing system. In this way, if one of diodes D1, D2 per branch is defective, it is possible to continue to operate energy storage cell 10, 20 with the leakage current of intact diode D1, D2 intended for this purpose. An undesirably high charging current, which is essentially only limited by the internal resistances of the two energy storage cells 10, 20, is thus avoided.

In one further variant not shown in a figure, it may be provided that, in addition to diode D1, D2, a fuse element is provided, which is provided to allow a current limitation of the current for electrical energy storage cell 10, 20 or, if necessary, an interruption of a charging process of electrical energy storage cells 10, 20.

In one further variant not shown in a figure, it may be provided that, in addition to diode D1, D2, a switch element is provided, which is provided to allow a manual shut-off of the current for electrical energy storage cell 10, 20. Some device standards require this. However, as a result the passive charging process is then no longer possible.

FIG. 2 shows a family of parameters of the leakage current plotted against the reverse voltages of Schottky diodes. A family of leakage currents is plotted against a curve of the reverse voltage of the Schottky diode at different ambient temperatures Tj. It is apparent that leakage currents IR are very strongly dependent on ambient temperature Tj, the individual curve progressions of the leakage currents otherwise essentially running in parallel.

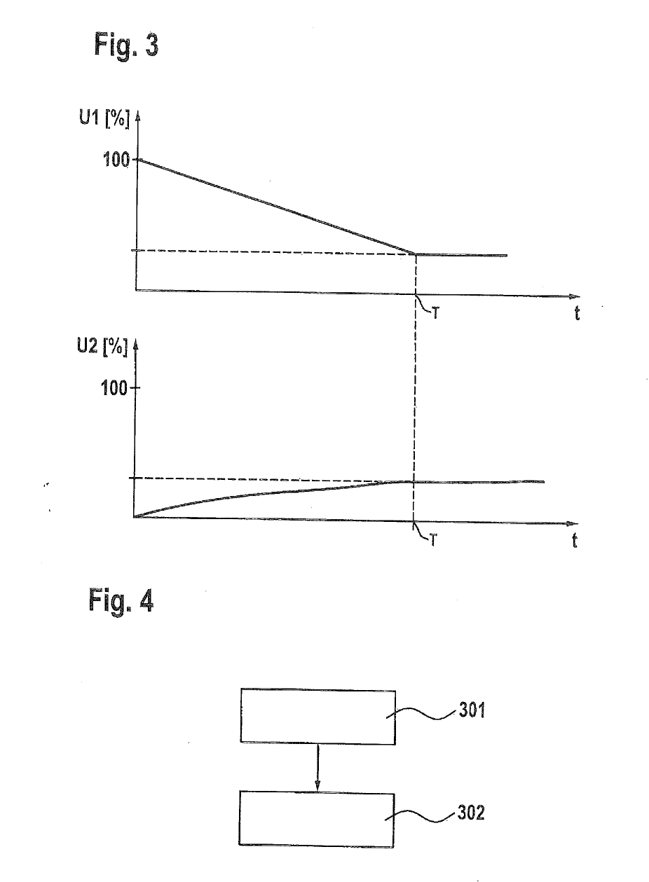

FIG. 3 shows a convergence of the charge states of the two electrical energy storage cells 10, 20 in two schematic time diagrams. The top diagram shows a curve of voltage U1 of first electrical energy storage cell 10. It is apparent that a voltage or charge state of first energy storage cell 10 continuously decreases starting from 100%, until at a point in time T an equilibrium of the charge states of the two electrical energy storage cells 10, 20 has been achieved, after which the voltage U1 of first electrical energy storage cell 10 does not drop further. Further discharge of first energy storage cell 10 thereafter takes place only based on self-discharge.

In the bottom diagram of FIG. 3, the voltage progression of second electrical energy storage cell 20 is plotted against time t. It is apparent that here voltage U2 increases proceeding from zero, until at point in time T the voltage state has leveled out at a defined value of the voltage capacity of second energy storage cell 20. As a result, it is thus discernible that the operating points of the two energy storage cells 10, 20 take effect automatically.

A major advantage of the method according to the present invention is that no control unit whatsoever must be provided because a level of the leakage current merely depends on the temperature, so that the aspired balancing or equalization process of the charges takes place purely passively.

It is another advantage of the present invention that energy withdrawal from the two electrical energy storage cells 10, 20 takes place more uniformly during the normal operation of electrical device 200 following the charging process. This is derived from the fact that the electric power is proportional to the square of the electric current, whereby power dissipation of the equalized or balanced electrical energy storage cells 10, 20 is considerably lower and batteries 10, 20 may thus be operated more gently. Even in the event that the voltage or charge states of the two electrical energy storage cells 10, 20 do not balance, a more uniform load of the two electrical energy storage cells 10, 20 is made possible during normal operation of electrical device 200. This has the advantageous impact of an extended service life and of increased reliability of electrical energy storage cells 10, 20 due to a lower temperature.

FIG. 4 shows a schematic flow of one specific embodiment of the method according to the present invention.

In a first step 301, the energy store device is placed in a charge mode by operational non-use, whereby the balancing process starts automatically.

In a second step 302, a balancing of charge states of energy storage cells 10, 20 is carried out with the aid of leakage currents of diodes D1, D2.

In summary, the present invention takes advantage of an otherwise frequently undesirable so-called “dirt effect” of a Schottky diode in the form of leakage currents to equalize an electrical energy store system including at least two battery storage cells in a purely passive way or to energetically balance the same. The described leakage currents are advantageously considerably lower than the maximal battery charging current, so that a safety aspect of charging the battery storage cells advantageously is very high.

The charging currents advantageously split automatically, the energy balancing being essentially dependent on the following influencing variables:
capacity of the batteries in the system;
forward voltage of the conducting path of the power OR-ing circuit;
number of the available diodes; and
leakage currents of the diodes.

The present invention may advantageously be used in particular in the field of power tools, in which there is sufficient space in the power tools for multicell energy store systems. This may be the case, for example, in electric lawnmowers; of course, it is possible to use the present invention for any systems including at least two battery storage cells, the battery technology used not being relevant.

Those skilled in the art will thus suitably combine the named features with each other or modify them, without departing from the core of the present invention.

What is claimed is:

1. An electrical energy store device, comprising:
at least two energy storage cells, which are interconnected in series in each case with at least one diode to form a neutral point;
wherein, if dissimilar charge states of the energy storage cells are present, the charge states of the energy storage cells are balanceable with the aid of leakage currents of the diodes.

2. The energy store device of claim 1, wherein a number of energy storage cells are interconnected to form the neutral point.

3. The energy store device of claim 1, wherein in each case n diodes are connected in series to at least one energy storage cell.

4. The energy store device of claim 1, wherein in each case at least one fuse element is connected in series to at least one electrical energy storage cell.

5. The energy store device of claim 1, wherein the diodes include Schottky diodes.

6. A method for operating an electrical energy store device, the method comprising:
providing operational non-use of the device, wherein the device includes at least two energy storage cells, which are interconnected in series in each case with at least one diode to form a neutral point; and
balancing charge states of the energy storage cells with the aid of leakage currents of the diodes.

7. The method of claim 6, wherein the diodes include Schottky diodes.

8. The device of claim 1, wherein the device is a power tool, which is in a non-operational operating mode.

9. The device of claim 8, wherein the power tool is a lawnmower.
